(19) United States
(12) Patent Application Publication
(10) Pub. No.: US 2017/0288533 A1
(43) Pub. Date: Oct. 5, 2017

(54) ELECTRICAL CIRCUIT FOR VOLTAGE CONVERSION

(71) Applicant: Advanced Charging Technologies, LLC, Irvine, CA (US)

(72) Inventors: Randall L. Sandusky, Divide, CO (US); Neaz E. Farooqi, Colorado Springs, CO (US)

(21) Appl. No.: 15/625,939

(22) Filed: Jun. 16, 2017

Related U.S. Application Data
(63) Continuation-in-part of application No. 14/925,855, filed on Oct. 28, 2015.
(60) Provisional application No. 62/351,212, filed on Jun. 16, 2016.
(60) Provisional application No. 62/236,731, filed on Oct. 2, 2015.
(60) Provisional application No. 62/208,520, filed on Aug. 21, 2015.
(60) Provisional application No. 62/180,549, filed on Jun. 16, 2015.
(60) Provisional application No. 62/175,972, filed on Jun. 15, 2015.
(60) Provisional application No. 62/094,884, filed on Dec. 19, 2014.
(60) Provisional application No. 62/074,525, filed on Nov. 3, 2014.
(60) Provisional application No. 62/069,672, filed on Oct. 28, 2014.

(51) Int. Cl. H02M 3/07

(52) U.S. Cl. CPC H02M 3/07

(57) ABSTRACT

A circuit includes a second voltage converter electrically coupled to a comparator and first voltage converter. The first voltage converter receives first and second clocks and an input signal at a first voltage and generates an intermediate signal at a second voltage based on the input signal and the first and second clocks. The second voltage converter receives the intermediate signal, the second clock, and a comparison signal and generates an output signal at a third voltage based on the intermediate and comparison signals and the second clock. The comparator receives a reference voltage, the output signal, and the first clock, compares the reference voltage and output signal, and generates the comparison signal based on the first clock and the comparison of the reference voltage and output signal. The second voltage converter adjusts the third voltage of the output signal to approach the reference voltage based on the comparison signal.

### CROSS-REFERENCE TO RELATED APPLICATION

This patent application claims benefit of and priority to U.S. Provisional App. No. 62/351,212 filed Jun. 16, 2016, which is incorporated herein by reference in its entirety. This patent application is a continuation-in-part of application Ser. No. 14/925,855, filed Oct. 28, 2015, which claims benefit of U.S. Provision Applications Nos. 62/069,672 filed Oct. 28, 2014, 62/074,525 filed Nov. 3, 2014, 62/094,884 filed Dec. 19, 2014, 62/175,972 filed Jun. 15, 2015, 62/180,549 filed Jun. 16, 2015, 62/208,520 filed Aug. 21, 2015, 62/236,731 filed Oct. 2, 2015, which are incorporated herein by reference in their entireties.

### FIELD

The embodiments discussed in the present disclosure are related to voltage conversion within an electronic device.

### BACKGROUND

The use of electronic devices is a useful tool for work, personal, and entertainment uses. Despite the proliferation of electronic devices, there still remains various limitations for delivering power to electronic devices.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

One or more embodiments of the present disclosure may include a voltage conversion circuit. The voltage conversion circuit may include a first stage voltage converter. The first stage voltage converter may be configured to receive an input signal at a first voltage level. The first stage voltage converter may also be configured to receive a first clock signal and a second clock signal. The first stage voltage converter may additionally be configured to generate an intermediate signal at a second voltage level based on the input signal, the first clock signal, and the second clock signal. The voltage conversion circuit may also include a second stage voltage converter electrically coupled in series with the first stage voltage converter. The second stage voltage converter may be configured to receive the intermediate signal. The second stage voltage converter may also be configured to receive the second clock signal and a combined comparison signal. The second stage voltage converter may additionally be configured to generate an output signal at a third voltage level based on the intermediate signal, the combined comparison signal, and the second clock signal. The voltage conversion circuit may additionally include a comparison circuit electrically coupled in parallel to the second stage voltage converter. The comparison circuit may be configured to receive a reference signal at a fourth voltage level. The comparison circuit may also be configured to receive the output signal and the first clock signal. The comparison circuit may additionally be configured to compare the reference signal and the output signal. The comparison circuit may be configured to generate the combined comparison signal based on the first clock signal and the comparison of the reference signal and the output signal. The second stage voltage converter may be configured to adjust the third voltage level of the output signal to approach the fourth voltage level of the reference signal based on the combined comparison signal.

One or more embodiments of the present disclosure may include a voltage conversion circuit. The voltage conversion circuit may include a multiple stage voltage converter. The multiple stage voltage converter may be configured to receive an input signal at a first voltage level. The multiple stage voltage converter may also be configured to receive a first clock signal and a second clock signal. The multiple stage voltage converter may additionally be configured to generate an intermediate signal at a second voltage level based on the input signal, the first clock signal, and the second clock signal. The voltage conversion circuit may also include a switching inductive circuit electrically coupled in series with the multiple stage voltage converter. The switching inductive circuit may be configured to receive the intermediate signal. The switching inductive circuit may also be configured to receive a comparison signal. The switching inductive circuit may additionally be configured to generate an output signal at a third voltage level based on the intermediate signal and the comparison signal. The voltage conversion circuit may additionally include a regulator circuit electrically coupled in parallel to the switching inductive circuit. The regulator circuit may be configured to receive the output signal. The regulator circuit may also be configured to receive a reference signal at a fourth voltage level. The regulator circuit may additionally be configured to receive a third clock signal. The regulator circuit may be configured to compare the output signal and the reference signal. The regulator circuit may also be configured to generate the comparison signal based on the third clock signal and the comparison of the output signal and the reference signal. The switching inductive circuit may be configured to adjust the third voltage level of the output signal to approach the fourth voltage level of the reference signal based on the comparison signal.

One or more embodiments of the present disclosure may include a voltage conversion circuit. The voltage conversion circuit may include a multiple stage voltage converter. The multiple stage voltage converter may be configured to receive a boost signal at a first voltage level. The multiple stage voltage converter may also be configured to receive a first clock signal and a second clock signal. The multiple stage voltage converter may additionally be configured to generate an output signal at a second voltage level based on the boost signal, the first clock signal, and the second clock signal. The voltage conversion circuit may also include a boost switching regulator electrically coupled in series with the multiple stage voltage converter. The boost switching regulator may be configured to receive an input signal, a third clock signal, and the output signal. The boost switching regulator may also be configured to receive a reference signal at a third voltage level. The boost switching regulator may additionally be configured to compare the reference signal and the output signal. The boost switching regulator may be configured to generate the boost signal based on the input signal, the third clock signal, and the comparison of the reference signal and the output signal. The boost switching regulator may also be configured to adjust the first voltage level of the boost signal to cause the second voltage level of the output signal generated by the multiple stage voltage converter to approach the third voltage level of the reference signal.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example system of electrical components implementing voltage conversion;

FIG. 2 illustrates another example system of electrical components implementing voltage conversion;

FIG. 3 illustrates an additional example system of electrical components implementing voltage conversion;

FIG. 4 illustrates an example system of electrical components implementing voltage conversion; and

FIG. 5 illustrates another example system of electrical components implementing voltage conversion.

### DETAILED DESCRIPTION

Some embodiments of the present disclosure relate to improvements to voltage conversion within an electronic device. For example, a voltage conversion circuit may receive an electrical signal at a first voltage and may convert and output the electrical signal at a second voltage. The voltage conversion circuit may include multiple voltage converter stages, arranged in a cascaded configuration, so as to adjust the electrical signal in smaller steps at each voltage converter stage rather than adjust the electrical signal in one single step. The conversion of the electrical signal performed by each voltage converter stage may be regulated or unregulated. For example, the voltage conversion circuit may include a first voltage converter stage that is unregulated and a second voltage converter stage that is regulated. In another example, both the first voltage converter stage and the second voltage converter stage may be regulated.

In some embodiments, the voltage conversion circuit may include a comparator electrically coupled in parallel to one or more of the voltage converter stages. The comparator may be configured to regulate one or more of the voltage converter stages by comparing the output electrical signal to a reference signal and providing a comparison signal to the one or more voltage converter stages. The one or more voltage converter stages may adjust an amount the electrical signal is modified in each regulated voltage converter stage based on the comparison signal to cause the second voltage of the electrical signal at the output to approach a voltage of the reference signal.

Additionally, in some embodiments, the multiple voltage converter stages may be unregulated and the output electrical signal may be regulated using a regulator electrically coupled in parallel to a switching inductive circuit. The switching inductive circuit may receive the electrical signal from the output of the multiple voltage converter stages and may output the electrical signal at a third voltage. The regulator may compare the electrical signal at the output of the switching inductive circuit to the reference signal. The regulator may provide a signal to the switching inductive circuit to modify a duty cycle of the switching inductive circuit to adjust the electrical signal at the output of the switching inductive circuit to cause the third voltage of the electrical signal at the output to approach the voltage of the reference signal.

Alternatively, the multiple voltage converter stages may be unregulated and the electrical signal at the output may be regulated using a boost switching regulator electrically coupled in series with the multiple voltage converter stages. For example, the boost switching regulator may be electrically coupled in series with the first voltage converter stage. The boost switching regulator may receive the electrical signal at the first voltage and may convert and output the electrical signal at the second voltage. The multiple voltage converter stages may receive the electrical signal at the second voltage and may convert and output the electrical signal at a third voltage. The boost switching regulator may compare the electrical signal at the output of the multiple voltage converter stages to the reference signal and may adjust the second voltage of the electrical signal at the output of the boost switching regulator so as to cause the third voltage of electrical signal at the output of multiple voltage converter stages to approach the voltage of the reference signal.

The voltage conversion circuit may be configured to increase power efficiency, increase accuracy of the voltage of the output electrical signal, and/or reduce an amount of time needed to output the electrical signal at the converted voltage level.

Embodiments of the present disclosure are explained with reference to the accompanying drawings.

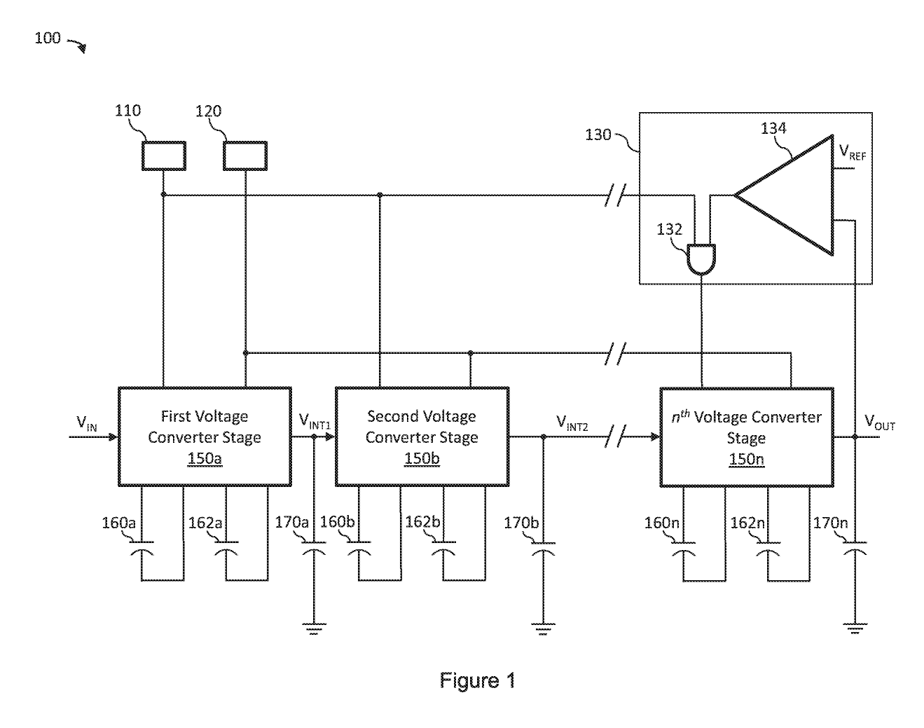

FIG. 1 illustrates an example system 100 of electrical components implementing voltage conversion, in accordance with one or more embodiments of the present disclosure. The system may include a first clock generator 110, a second clock generator 120, a comparison circuit 130, and multiple voltage converter stages 150 (such as first voltage converter stage 150a, second voltage converter stage 150b, . . . and n^{th} voltage converter stage 150n).

In some embodiments, the system 100 may implement a voltage conversion circuit configured to receive an electrical signal at voltage V_{IN} and convert and output the electrical signal at voltage V_{OUT}. In these and other embodiments, the system 100 may implement a down converter in which each voltage converter stage 150 may divide the voltage of the electrical signal, and V_{OUT} may be less than V_{IN}. Additionally or alternatively, the system 100 may implement an up converter in which each voltage converter stage 150 may multiply the voltage of the electrical signal, and V_{OUT} may be greater than V_{IN}.

In some embodiments, each of the voltage converter stages 150 may be electrically coupled in series with one or more other voltage converter stages 150, in a cascaded configuration. For example, the first voltage converter stage 150a may be electrically coupled in series with the second voltage converter stage 150b. In these and other embodiments, the number of voltage converter stages 150 may be a function of a factor of division or multiplication to convert the electrical signal at V_{IN} to V_{OUT}. For example, V_{IN} may be roughly equal to one hundred twenty volts and V_{OUT} may be roughly equal to four volts and each voltage converter stage 150 may divide the voltage of the electrical signal by a factor of three which may necessitate the use of four voltage converter stages 150 to convert one hundred twenty volts to roughly four volts (e.g. 120 v/3=40 v, 40 v/3=13.33 v, and 13.33 v/3=4.44 v≈4 v).

In some embodiments, each of the voltage converter stages 150 may convert the voltage of the electrical signal by a same or similar factor. For example, each of the voltage converter stages 150 may be configured to divide the voltage of the electrical signal by a factor of four. In these and other embodiments, each of the voltage converter stages 150 may convert the voltage of the electrical signal by a different factor. For example, the first voltage converter stage 150a may multiply the voltage of the electrical signal by a factor of five and the second voltage converter stage 150b may multiply the voltage of the electrical signal by a factor of seven. Additionally or alternatively, the factor for converting the voltage of the electrical signal for two voltage converter stages 150 may be the same and the factor for converting the voltage of the electrical signal for the other voltage converter stages 150 may be different. For example, the first voltage converter stage 150a and the second voltage converter stage 150b may divide the voltage of the electrical signal by a factor of eight and the n^{th} voltage converter stage 150n may divide the voltage of the electrical signal by a factor of five.

In some embodiments, one or more of the voltage converter stages 150 may be unregulated. In these and other embodiments, the unregulated voltage converter stages 150 may include internal components with duty cycles based on fixed clock signals. For example, the duty cycle of the internal components of the first voltage converter stage 150a and the second voltage converter stage 150b may be based on a first clock signal generated by the first clock generator 110 and a second clock signal generated by the second clock generator 120. In these and other embodiments, the first clock signal and the second clock signal may be duty cycle clocks that regulate operation of the internal components of the unregulated voltage converter stages 150. For example, the first clock signal and the second clock signal may both be fifty percent duty cycle clocks. Additionally or alternatively, the second clock generator 120 may be a Dickson charge pump.

In some embodiments, a last voltage converter stage 150 in the cascade configuration may be regulated by the comparison circuit 130. For example, the n^{th} voltage converter stage 150n is the last voltage converter stage 150 in the cascade configuration and may be regulated by the comparison circuit 130. In these and other embodiments, the regulated voltage converter stage 150 may include internal components with duty cycles based on a variable clock signal generated by the comparison circuit 130. In these and other embodiments, the n^{th} voltage converter stage 150n may be regulated due to the duty cycle of at least a portion of the internal components of the n^{th} voltage converter stage 150n being based on a combined comparison signal generated by the comparison circuit 130. For example, the duty cycle of a first portion of the internal components of the n^{th} voltage converter stage 150n may be based on the second clock signal and the duty cycle of a second portion of the internal components of the n^{th} voltage converter stage 150n may be based on the combined comparison signal. The combined comparison signal is discussed in more detail below.

In some embodiments, the first voltage converter stage 150a may receive the electrical signal at V_{IN}, the first clock signal, and the second clock signal. In these and other embodiments, the first voltage converter stage 150a may convert the voltage of the electrical signal to V_{INT1} based on V_{IN}, the first clock signal, and the second clock signal. As discussed above, the duty cycle of the internal components of the first voltage converter stage 150a may be based on the first clock signal and the second clock signal. In these and other embodiments, the duty cycle of the internal components of the first voltage converter stage 150a may control an amount the voltage of the electrical signal is converted by the first voltage converter stage 150a. In some embodiments, V_{INT1} may be greater than or less than V_{IN} depending on whether the system 100 is implementing an up converter or a down converter.

In some embodiments, the second voltage converter stage 150b may receive the first clock signal and the second clock signal. In these and other embodiments, the duty cycle of the internal components of the second voltage converter stage 150b may be based on the first clock signal and the second clock signal. In some embodiments, the second voltage converter stage 150b may receive the electrical signal at V_{INT1} and may convert the voltage of the electrical signal to V_{INT2} based on V_{INT1}, the first clock signal, and the second clock signal. Additionally or alternatively, V_{INT2} may be greater or less than V_{INT1} depending on whether the system 100 is implementing an up converter or a down converter.

In some embodiments, the n^{th} voltage converter stage 150n may receive the electrical signal at V_{INT2}, the combined comparison signal, and the second clock signal. In these and other embodiments, the n^{th} voltage converter stage 150n may convert the voltage of the electrical signal to V_{OUT} based on the second clock signal and the combined comparison. Additionally or alternatively, V_{OUT} may be greater or less than V_{INT2} depending on whether the system 100 is implementing an up converter or a down converter.

In some embodiments, the comparison circuit 130 may be electrically coupled in parallel to the last voltage converter stage 150. For example, the comparison circuit 130 may be electrically coupled in parallel to the n^{th} voltage converter stage 150n (e.g., the last voltage converter stage 150). In these and other embodiments, the comparison circuit may include a comparator 134 and a logic element 132.

In some embodiments, the comparator 134 may receive the electrical signal at Vₒᵤₜ and a reference signal at V_{REF}. In these and other embodiments, V_{REF} may be a voltage that V_{OUT} is to be equal or similar to. In some embodiments, V_{REF} may be statically set prior to operation of the system 100 or V_{REF} may be dynamically set during operation of the system 100. In some embodiments, V_{REF} may be independent of the various voltages of the electrical signal within the system 100.

In some embodiments, the comparator 134 may compare V_{REF} and V_{OUT} and may generate a comparison signal based on a voltage difference between V_{REF} and V_{OUT}. In these and other embodiments, a voltage of the comparison signal may be based on an amount of the voltage difference between V_{REF} and V_{OUT}. For example, the voltage of the comparison signal in which the voltage difference between V_{REF} and V_{OUT} is three millivolts may be lower than the voltage of the comparison signal in which the voltage difference between V_{REF} and V_{OUT} is ten millivolts. In another example, the voltage of the comparison signal in which the voltage difference between V_{REF} and V_{OUT} is fifteen millivolts may be greater than the voltage of the comparison signal in which the voltage difference between V_{REF} and V_{OUT} is eight millivolts. Additionally or alternatively, the comparison signal may be a binary signal that is either on (e.g., high) or off (e.g., low).

In some embodiments, the logic element 132 may receive the first clock signal and the comparison signal. In these and other embodiments, the logic element 132 may generate the combined comparison signal based on the first clock signal and the comparison signal. Additionally or alternatively, the logic element 132 may gate the comparison signal and the first clock signal and may generate the combined comparison signal based on the gating of the comparison signal and the first clock signal. In some embodiments, the logic element 132 may include a logic gate such as an AND gate and may be configured to generate the combined comparison signal if both the first clock signal and the comparison signal are being generated and are above a threshold voltage. In some embodiments, the AND gate may be a digital logic element. In some embodiments, if the voltage of both the first clock signal and the comparison signal are above the threshold voltage, the voltage of the combined comparison signal may increase as the voltage of the comparison signal increases. Additionally or alternatively, if the voltage of both the first clock signal and the comparison signal are above the threshold voltage, the voltage of the combined comparison signal may decrease as the voltage of the comparison signal decreases. Additionally or alternatively, if the comparison signal and the first clock signal are both present, the logic element 132 may generate the combined comparison signal at a fixed voltage.

In some embodiments, the n^{th} voltage converter stage 150n (e.g., the last voltage converter stage 150) may adjust V_{OUT} so as to approach V_{REF} based on the combined comparison signal. In these and other embodiments, the duty cycle of the second portion of the internal components of the n^{th} voltage converter stage 150n may vary based on the voltage of the combined comparison signal. For example, if the voltage difference between V_{REF} and V_{OUT} is relatively small, meaning V_{OUT} is relatively close to V_{REF}, the voltage of the comparison signal and subsequently the voltage of the combined comparison signal may also be relatively small, which may cause the duty cycle of the second portion of the internal components of the n^{th} voltage converter stage 150n to be relatively shorter than if the voltage difference between V_{REF} and V_{OUT} was larger. In another example, if the voltage difference between V_{REF} and V_{OUT} is relatively large, meaning V_{OUT} is not relatively close to V_{REF}, the voltage of the comparison signal and subsequently the voltage of the combined comparison signal may also be relatively large which may cause the duty cycle of the second portion of the internal components of the n^{th} voltage converter stage 150n to be relatively longer than if the voltage difference between V_{REF} and V_{OUT} was smaller.

In some embodiments, if V_{OUT} is the same or similar to V_{REF}, one or more signals provided to the voltage converter stages 150 may be turned off. For example, if V_{OUT} is the same or similar to V_{REF}, the voltage of the comparison signal may drop below the threshold voltage and the logic element 132 may not generate or provide the combined comparison signal to the n^{th} voltage converter stage 150n. In another example, if V_{OUT} is the same or similar to V_{REF}, the first clock generator 110 may be configured to stop transmitting the first clock signal. In some embodiments, V_{OUT} may be the same or similar to V_{REF} when the difference between V_{REF} and V_{OUT} is less than or equal to ten millivolts.

In some embodiments, the system 100 may also include multiple flyback capacitors 160 and 162 (such as first flyback capacitor 160a, second flyback capacitor 162a, third flyback capacitor 160b, fourth flyback capacitor 162b, . . . and n^{th} flyback capacitors 160n and 162n) and multiple hold capacitors 170 (such as first hold capacitor 170a, second hold capacitor 170b, . . . and n^{th} hold capacitor 170n).

In some embodiments, each of the voltage converter stages 150 may be electrically coupled to one or more flyback capacitors 160 and 162. For example, the first voltage converter stage 150a may be electrically coupled to the first flyback capacitor 160a and the second flyback capacitor 162a. In these and other embodiments, the flyback capacitors 160 and 162 may be configured so as to increase accuracy of converting the electrical signal from V_{IN} to V_{OUT}.

In some embodiments, the hold capacitors may be electrically coupled to one or more voltage converter stages 150 and ground. For example, the first hold capacitor 170a may be electrically coupled to the first voltage converter stage 150a, the second voltage converter stage 150b, and ground. In these and other embodiments, the hold capacitors 170 may be configured to minimize a ripple of the various voltages of the electrical signal within the system 100. For example, the first hold capacitor 170a may be configured to minimize a ripple of voltage V_{INT1} of the electrical signal.

In some embodiments, the flyback capacitors 160 and 162 and the hold capacitors 170 located upstream may be rated for higher voltages or lower voltages than the flyback capacitors 160 and 162 and hold capacitors located downstream. In these and other embodiments, whether upstream capacitors are rated higher or lower than the downstream capacitors may depend on whether the system 100 is implementing an up converter or a down converter. For example, if the system 100 is implementing a down converter, the first flyback capacitor 160a and the second flyback capacitor 162a may be rated for a higher voltage than the n^{th} flyback capacitors 160n and 162n. In another example, if the system 100 is implementing an up converter, the first flyback capacitor 160a and the second flyback capacitor 162a may be rated for a lower voltage than the n^{th} flyback capacitors 160n and 162n.

Modifications, additions, or omissions may be made to FIG. 1 without departing from the scope of the present disclosure. For example, while illustrated as including three voltage converter stages 150, the system 100 may include any number of voltage converter stages 150, such as two voltage converters stages 150 or five voltage converter stages 150. As another example, while illustrated as including two clock generators 110 and 120, the system 100 may include any number of clock generators 110 and 120, such as one clock generator 110 or 120, three clock generators 110 and 120, or seven clock generators 110 and 120. As an additional example, while the comparison circuit 130 is illustrated as including a single comparator 134 and a single logic element 132, the comparison circuit 130 may include any number of comparators 134 and logic elements 132, such as two comparators 134 and logic elements 132 or four comparators 134 and three logic elements 132. Additionally, while illustrated as including six flyback capacitors 160 and 162 and three hold capacitors 170, the system 100 may include any number of flyback capacitors 160 and 162 and/or hold capacitors 170, such as one flyback capacitor 160 or 162 or one hold capacitor 170, three flyback capacitors 160 and 162 and hold capacitors 170, or twelve flyback capacitors 160 and 162 and six hold capacitors 170.

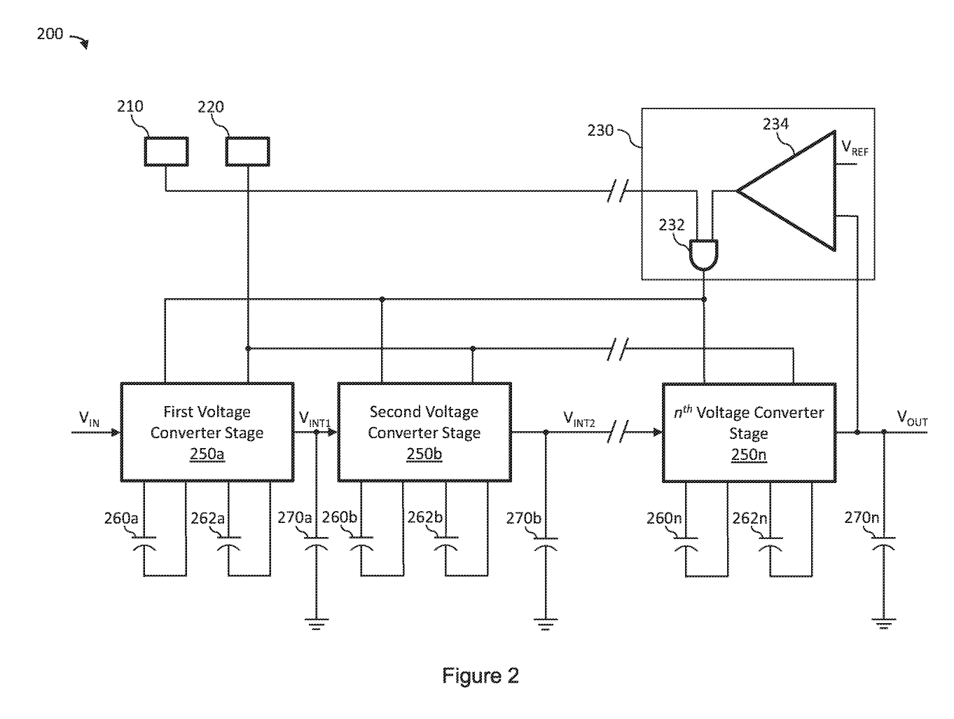

FIG. 2 illustrates another example system 200 of electrical components implementing voltage conversion, in accordance with one or more embodiments of the present disclosure. The system 200 may include a first clock generator 210, a second clock generator 220, a comparison circuit 230, and multiple voltage converter stages 250 (such as first voltage converter stage 250a, second voltage converter stage 250b, . . . and n^{th} voltage converter stage 250n). The first clock generator 210 and the second clock generator 220 may be similar or comparable to the first clock generator 110 and the second clock generator 120 discussed in conjunction with FIG. 1. Additionally, the system 200 may include multiple flyback capacitors 260a-n and 262a-n and hold capacitors 270a-n. The flyback capacitors 260a-n and 262a-n and the hold capacitors 270a-n may be similar or comparable to the flyback capacitors 160a-n and 162a-n and the hold capacitors 170a-n discussed in conjunction with FIG. 1.

In some embodiments, the system 200 may implement a voltage conversion circuit configured to receive an electrical signal at voltage V_{IN} and convert and output the electrical signal at voltage V_{OUT}. In these and other embodiments, the system 200 may implement a down converter in which each voltage converter stage 250 may divide the voltage of the electrical signal, and V_{OUT} may be less than V_{IN}. Additionally or alternatively, the system 200 may implement an up converter in which each voltage converter stage 250 may multiply the voltage of the electrical signal, and V_{OUT} may be greater than V_{IN}.

In some embodiments, the voltage converter stages 250 may be electrically coupled in a cascaded configuration similar to the voltage converter stages 150 discussed in conjunction with FIG. 1. In these and other embodiments, each of the voltage converter stages 250 may be regulated by the comparison circuit 230, in that the duty cycle of a portion of the internal components of the voltage converter stages 250 may be based on the combined comparison signal generated by the comparison circuit 230.

In some embodiments, the first voltage converter stage 250a may receive the electrical signal at V_{IN} and may convert the voltage of the electrical signal to V_{INT1} based on V_{IN}, the second clock signal, and the combined comparison signal. In these and other embodiments, the second voltage converter stage 250b may receive the electrical signal at V_{INT1} and may convert the voltage of the electrical signal to V_{INT2} based on V_{INT1}, the second clock signal, and the combined comparison signal. In some embodiments, the n^{th} voltage converter stage 250n may receive the electrical signal at V_{INT2} and may convert the voltage of the electrical signal to V_{OUT} based on the second clock signal and the combined comparison signal.

In some embodiments, the comparison circuit may include a comparator 234 and a logic element 232. In these and other embodiments, the comparison circuit 230 may be electrically coupled in parallel to the last voltage converter stage 250 (e.g., the n^{th} voltage converter stage 250n). Additionally or alternatively, the comparison circuit 230 may be electrically coupled to each of the voltage converter stages 250. In some embodiments, the comparison circuit 230 may generate the combined comparison signal in a similar manner to the comparison circuit 130 of FIG. 1.

In some embodiments, each of the voltage converter stages 250 may adjust the various voltages of the electrical signal so that V_{OUT} may approach V_{REF} based on the combined comparison signal. For example, the first voltage converter stage 250a may adjust V_{INT1} based on the combined comparison signal. As another example, the second voltage converter stage 250b may adjust V_{INT2} based on the combined comparison signal. As an additional example, the n^{th} voltage converter stage 250n may adjust V_{OUT} based on the combined comparison signal

In some embodiments, if V_{OUT} is the same or similar to V_{REF}, one or more signals provided to the voltage converter stages 250 may be turned off as discussed above in conjunction with FIG. 1. In these and other embodiments, if V_{OUT} is the same or similar to V_{REF}, logic element 232 may not generate or provide the combined comparison signal to each of the voltage converter stages 250. In another example, if V_{OUT} is the same or similar to V_{REF}, the first clock generator 210 may be configured to stop transmitting the first clock signal which may cause the logic element 232 to not generate or provide the combined comparison signal to the voltage converter stages 250.

In some embodiments, regulating each of the voltage converter stages 250 using the same comparison circuit 230 may cause V_{OUT} to approach V_{REF} relatively slower than a system that only regulates the last voltage converter stage 250 (e.g., the n^{th} voltage converter stage 250n). In these and other embodiments, regulating each of the voltage converter stages 250 using the same comparison circuit 230 may allow conversion of a larger range of voltages than a system that only regulates the last voltage converter stage 250. Additionally or alternatively, regulating each of the voltage converter stages 250 using the same comparison circuit 230 may decrease switching loss experienced by the voltage converter stages 250 compared to a system that only regulates the last voltage converter stage 250.

Modifications, additions, or omissions may be made to FIG. 2 without departing from the scope of the present disclosure. For example, while illustrated as including three voltage converter stages 250, the system 200 may include any number of voltage converter stages 250, such as two voltage converters stages 250 or five voltage converter stages 250. As another example, while illustrated as including two clock generators 210 and 220, the system 200 may include any number of clock generators 210 and 220, such as one clock generator 210 or 220, three clock generators 210 and 220, or seven clock generators 210 and 220. As an additional example, while the comparison circuit 230 is illustrated as including a single comparator 234 and a single logic element 232, the comparison circuit 230 may include any number of comparators 234 and logic elements 232, such as two comparators 234 and logic elements 232 or four comparators 234 and three logic elements 232. Additionally, while illustrated as including six flyback capacitors 260 and 262 and three hold capacitors 270, the system 200 may include any number of flyback capacitors 260 and 262 and/or hold capacitors 270, such as one flyback capacitor 260 or 262 or one hold capacitor 270, three flyback capacitors 260 and 262 and hold capacitors 270, or twelve flyback capacitors 260 and 262 and six hold capacitors 270.

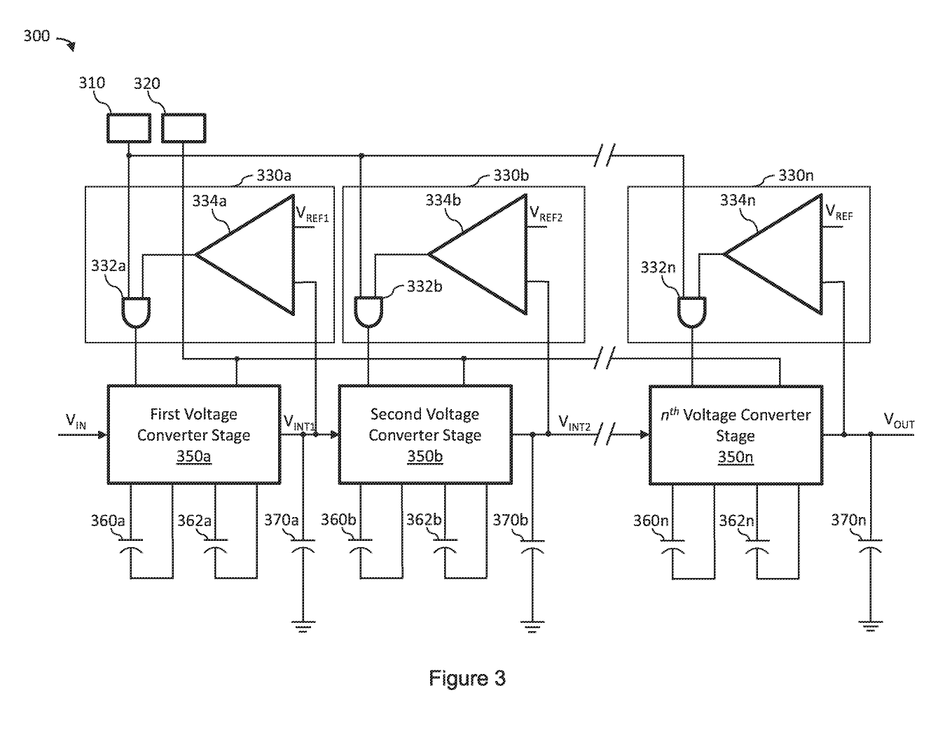

FIG. 3 illustrates an additional example system 300 of electrical components implementing voltage conversion, in accordance with one or more embodiments of the present disclosure. The system 300 may include a first clock generator 310, a second clock generator 320, multiple comparison circuits 330 (such as first comparison circuit 330a, second comparison circuit 330b, . . . and n^{th} comparison circuit 330n), and multiple voltage converter stages 350 (such as first voltage converter stage 350a, second voltage converter stage 350b, . . . and n^{th} voltage converter stage 350n). The first clock generator 310 and the second clock generator 320 may be similar or comparable to the first clock generator 110 and the second clock generator 120 discussed in conjunction with FIG. 1. Additionally, the system 300 may include multiple flyback capacitors 360a-n and 362a-n and hold capacitors 370a-n. The flyback capacitors 360a-n and 362a-n and the hold capacitors 370a-n may be similar or comparable to the flyback capacitors 160a-n and 162a-n and the hold capacitors 170a-n discussed in conjunction with FIG. 1.

In some embodiments, the system 300 may implement a voltage conversion circuit configured to receive an electrical signal at voltage V_{IN} and convert and output the electrical signal at voltage V_{OUT}. In these and other embodiments, the system 300 may implement a down converter in which each voltage converter stage 350 may divide the voltage of the electrical signal, and V_{OUT} may be less than V_{IN}. Additionally or alternatively, the system 300 may implement an up converter in which each voltage converter stage 350 may multiply the voltage of the electrical signal, and V_{OUT} may be greater than V_{IN}.

In some embodiments, the voltage converter stages 350 may be electrically coupled in a cascaded configuration similar to the voltage converter stages 150 discussed in conjunction with FIG. 1. In these and other embodiments, each of the voltage converter stages 350 may be regulated by a different comparison circuit 330. Additionally or alternatively, each of the comparison circuits 330 may be electrically coupled in parallel to a different voltage converter stage 350. For example, the first comparison circuit 330a may be electrically coupled in parallel to the first voltage converter stage 350a and the second comparison circuit 330b may be electrically coupled in parallel to the second voltage converter stage 350b. In these and other embodiments, each of the comparison circuits 330 may be similarly configured and may operate independent of each other. In some embodiments, each of the comparison circuits 330 may include a comparator 334 (such as first comparator 334a, second comparator 334b, . . . and n^{th} comparator 334n) and a logic element 332 (such as first logic element 332a, second logic element 332b, . . . and n^{th} logic element 332n).

In some embodiments, the first comparison circuit 330a may be electrically coupled in parallel to the first voltage converter stage 350a. In these and other embodiments, the first voltage converter stage 350a may receive the electrical signal at V_{IN} and may convert the voltage of the electrical signal to V_{INT1} based on V_{IN}, the second clock signal, and a first combined comparison signal generated by the first comparison circuit 330a. In some embodiments, the first comparator 334a may receive the electrical signal at V_{INT1} and a first reference signal at V_{REF1}. In these and other embodiments, V_{REF1} may be a voltage that V_{INT1} is to be equal or similar to. In some embodiments, V_{REF1} may be statically set prior to operation of the system 300 or V_{REF1} may be dynamically set during operation of the system 300. In some embodiments, V_{REF1} may be independent of V_{IN} and/or V_{INT1} of the electrical signal.

In some embodiments, the first comparator 334a may compare V_{REF1} and V_{INT1} and may generate a first comparison signal based on a voltage difference between V_{REF1} and V_{INT1}. In these and other embodiments, a voltage of the first comparison signal may be based on an amount of the voltage difference between V_{REF1} and V_{INT1}.

In some embodiments, the first logic element 332a may receive the first clock signal and the first comparison signal. In these and other embodiments, the first logic element 332a may generate the first combined comparison signal based on the first clock signal and the first comparison signal. Additionally or alternatively, the first logic element 332a may gate the first comparison signal and the first clock signal and may generate the first combined comparison signal based on the gating of the first comparison signal and the first clock signal. In some embodiments, the first logic element 332a may include a logic gate such as an and gate and may be configured to generate the first combined comparison signal if the first clock signal and the first comparison signal are both being generated and are above a first threshold voltage. In some embodiments, if the voltage of the first clock signal and the first comparison signal are both above the first threshold voltage, the voltage of the first combined comparison signal may increase as the voltage of the first comparison signal increases. Additionally or alternatively, if the voltage of both the first clock signal and the first comparison signal are above the first threshold voltage, the voltage of the first combined comparison signal may decrease as the voltage of the first comparison signal decreases. In some embodiments, the first voltage converter stage 350a may adjust V_{INT1} so as to approach V_{REF1} based on the first combined comparison signal.

In some embodiments, if V_{INT1} is the same or similar to V_{REF1}, one or more signals provided to the first voltage converter stage 350a may be turned off. For example, if V_{INT1} is the same or similar to V_{REF1}, the voltage of the first comparison signal may drop below the first threshold voltage and the first logic element 332a may not generate or provide the first combined comparison signal to the first voltage converter stage 350a.

In some embodiments, the second comparison circuit 330b may be electrically coupled in parallel to the second voltage converter stage 350b. In these and other embodiments, the second voltage converter stage 350b may receive the electrical signal at V_{INT1} and may convert the voltage of the electrical signal to V_{INT2} based on V_{INT1}, the second clock signal, and a second combined comparison signal. In some embodiments, the second comparator 334b may receive the electrical signal at V_{INT2} and a second reference signal at V_{REF2}. In these and other embodiments, V_{REF2} may be a voltage that V_{INT2} is to be equal or similar to.

In some embodiments, the second comparator 334b may compare V_{REF2} and V_{INT2} and may generate a second comparison signal based on a voltage difference between V_{REF2} and V_{INT2}. In these and other embodiments, a voltage of the second comparison signal may be based on an amount of the voltage difference between V_{REF2} and V_{INT2}.

In some embodiments, the second logic element 332b may receive the first clock signal and the second comparison signal. In these and other embodiments, the second logic element 332b may generate the second combined comparison signal based on the first clock signal and the second comparison signal. In some embodiments, the second logic element 332b may include a logic gate such as an and gate and may be configured to generate the second combined comparison signal if both the first clock signal and the second comparison signal are being generated and are above a second threshold voltage. In some embodiments, the second voltage converter stage 350b may adjust V_{INT2} so as to approach V_{REF2} based on the second combined comparison signal.

In some embodiments, if V_{INT2} is the same or similar to V_{REF2}, one or more signals provided to the second voltage converter stage 350b may be turned off. For example, if V_{INT2} is the same or similar to V_{REF2}, the voltage of the second comparison signal may drop below the second threshold voltage and the second logic element 332b may not generate or provide the second combined comparison signal to the second voltage converter stage 350b.

In some embodiments, the n^{th} comparison circuit 330n may be electrically coupled in parallel to the n^{th} voltage converter stage 350n. In these and other embodiments, the n^{th} voltage converter stage 350n may receive the electrical signal at V_{INT2} and may convert the voltage of the electrical signal to V_{OUT} based on V_{INT2}, the second clock signal, and an n^{th} combined comparison signal. In some embodiments, the n^{th} comparator 334n may receive the electrical signal at V_{OUT} and a reference signal at V_{REF}. In these and other embodiments, V_{REF} may be a voltage that V_{OUT} is to be equal or similar to.

In some embodiments, the n^{th} comparator 334n may compare V_{REF} and V_{OUT} and may generate an n^{th} comparison signal based on a voltage difference between V_{REF} and V_{OUT}. In these and other embodiments, a voltage of the n^{th} comparison signal may be based on an amount of the voltage difference between V_{REF} and V_{OUT}.

In some embodiments, the n^{th} logic element 332n may receive the first clock signal and the n^{th} comparison signal. In these and other embodiments, the n^{th} logic element 332n may generate the n^{th} combined comparison signal based on the first clock signal and the n^{th} comparison signal. In some embodiments, the n^{th} logic element 332n may include a logic gate such as an and gate and may be configured to generate the n^{th} combined comparison signal if the first clock signal and the n^{th} comparison signal are both being generated and are above an n^{th} threshold voltage. In some embodiments, the n^{th} voltage converter stage 350n may adjust V_{OUT} so as to approach V_{REF} based on the n^{th} combined comparison signal.

In some embodiments, if V_{OUT} is the same or similar to V_{REF}, one or more signals provided to the n^{th} voltage converter stage 350n and/or other voltage converter stages 350 may be turned off. For example, if V_{OUT} is the same or similar to V_{REF}, the voltage of the n^{th} comparison signal may drop below the n^{th} threshold voltage and the n^{th} logic element 332n may not generate or provide the n^{th} combined comparison signal to the n^{th} voltage converter stage 350n. In another example, if V_{OUT} is the same or similar to V_{REF}, the first clock generator 310 may be configured to stop transmitting the first clock signal.

In some embodiments, regulating each of the voltage converter stages 350 using a different comparison circuit 330 for each voltage converter stage 350 may achieve a higher accuracy of converting the electrical signal to a voltage that is the same or similar to V_{REF} than in the systems 100 and 200 discussed conjunction with FIGS. 1 and 2. In these and other embodiments, regulating each of the voltage converter stages 350 using a different comparison circuit 330 for each voltage converter stage 350 may provide greater power efficiency since one or more signals transmitted to each voltage converter stage 350 may be independently turned off. Additionally or alternatively, the system 300 regulating each of the voltage converter stages 350 using a different comparison circuit 330 for each voltage converter stage 350 may be capable of converting a larger range of voltages than the systems 100 and 200 discussed conjunction with FIGS. 1 and 2, since the conversion performed by each voltage converter stage 350 may be adjusted independently.

Modifications, additions, or omissions may be made to FIG. 3 without departing from the scope of the present disclosure. For example, while illustrated as including three voltage converter stages 350, the system 300 may include any number of voltage converter stages 350, such as two voltage converters stages 350 or five voltage converter stages 350. As another example, while illustrated as including two clock generators 310 and 320, the system 300 may include any number of clock generators 310 and 320, such as one clock generator 310 or 320, three clock generators 310 and 320, or seven clock generators 310 and 320. As an additional example, while illustrated as including three comparison circuits 330, the system 300 may include any number of comparison circuits 330, such as two comparison circuits 330 or five comparison circuits 330. For example, while the comparison circuit 330 is illustrated as including a single comparator 334 and a single logic element 332, the comparison circuit 330 may include any number of comparators 334 and logic elements 332, such as two comparators 334 and logic elements 332 or four comparators 334 and three logic elements 332. Additionally, while illustrated as including six flyback capacitors 360 and 362 and three hold capacitors 370, the system 300 may include any number of flyback capacitors 360 and 362 and/or hold capacitors 370, such as one flyback capacitor 360 or 362 or one hold capacitor 370, three flyback capacitors 360 and 362 and hold capacitors 370, or twelve flyback capacitors 360 and 362 and six hold capacitors 370.

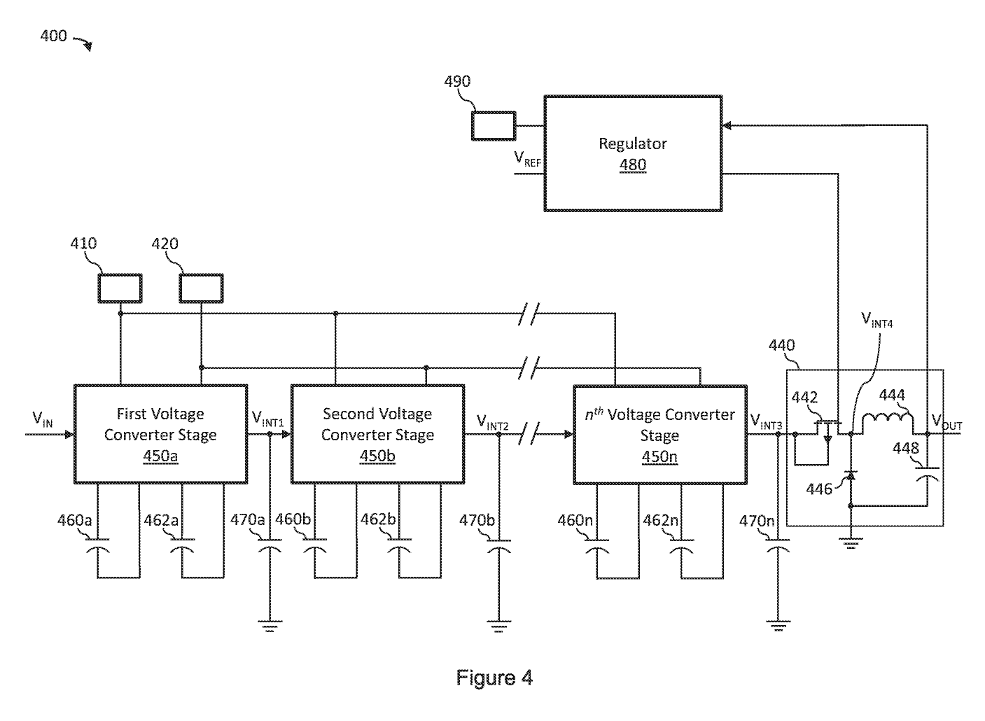

FIG. 4 illustrates an example system of electrical components implementing voltage conversion, in accordance with one or more embodiments of the present disclosure. The system 400 may include a first clock generator 410, a second clock generator 420, a third clock generator 490, a regulator 480, a switching inductive circuit 440, and multiple voltage converter stages 450 (such as first voltage converter stage 450a, second voltage converter stage 450b, . . . and n^{th} voltage converter stage 450n). The first clock generator 410 and the second clock generator 420 may be similar or comparable to the first clock generator 110 and the second clock generator 120 discussed in conjunction with FIG. 1. Additionally, the system 400 may include multiple flyback capacitors 460a-n and 462a-n and hold capacitors 470a-n. The flyback capacitors 460a-n and 462a-n and the hold capacitors 470a-n may be similar or comparable to the flyback capacitors 160a-n and 162a-n and the hold capacitors 170a-n discussed in conjunction with FIG. 1.

In some embodiments, the system 400 may implement a voltage conversion circuit configured to receive an electrical signal at voltage V_{IN} and convert and output the electrical signal at voltage V_{OUT}. In these and other embodiments, the system 400 may implement a down converter in which each voltage converter stage 450 may divide the voltage of the electrical signal, and V_{OUT} may be less than V_{IN}. Additionally or alternatively, the system 400 may implement an up converter in which each voltage converter stage 450 may multiply the voltage of the electrical signal, and V_{OUT} may be greater than V_{IN}.

In some embodiments, the voltage converter stages 450 may be electrically coupled in a cascaded configuration similar to the voltage converter stages 150 discussed in conjunction with FIG. 1. In these and other embodiments, the voltage converter stages 450 may be unregulated such that a duty cycle of internal components of the voltage converter stages 450 are based on fixed clock signals. For example, the duty cycle of the internal components of the voltage converter stages 450 may be based on a first clock signal generated by the first clock generator 410 and a second clock signal generated by the second clock generator 420 as discussed above in conjunction with FIG. 1.

In some embodiments, the first voltage converter stage 450a may receive the electrical signal at V_{IN} and may convert the voltage of the electrical signal to V_{INT1} and may output the electrical signal at V_{INT1} based on V_{IN}, the first clock signal, and the second clock signal. Likewise, the second voltage converter stage 450b may receive the electrical signal at V_{INT1} and may convert the voltage of the electrical signal to V_{INT2} and may output the electrical signal at V_{INT2} based on V_{INT1}, the first clock signal, and the second clock signal. In these and other embodiments, the n^{th} voltage converter stage 450n may receive the electrical signal at V_{INT2} and may convert the voltage of the electrical signal to V_{INT3} and may output the electrical signal at V_{INT3} based on V_{INT2}, the first clock signal, and the second clock signal.

In some embodiments, the switching inductive circuit 440 may be electrically coupled in series with the last voltage converter stage 450 (e.g., the n^{th} voltage converter stage 450n). In these and other embodiments, the switching inductive circuit 440 may include a switching element 442, an inductor 444, a capacitor 448, and a diode 446. In some embodiments, the switching element 442 may receive the electrical signal at V_{INT3} and a comparison signal generated by the regulator 480. In these and other embodiments, the switching element 442 may adjust the voltage of the electrical signal to V_{INT4} based on V_{INT3} and the comparison signal. The comparison signal is discussed in more detail below.

In some embodiments, the inductor 444 may receive the electrical signal at V_{INT4}, which may drive the inductor 444 and may output the electrical signal at V_{OUT}. In these and other embodiments, the capacitor 448 may be configured to minimize a ripple of V_{OUT} of the electrical signal. Additionally or alternatively, the diode 446 may be configured to provide a current when the switching element 442 is open and not generating the electrical signal at VI_{INT4}.

In some embodiments, the regulator 480 may be electrically coupled in parallel to the switching inductive circuit 440. In these and other embodiments, the regulator 480 may regulate the switching inductive circuit 440, in that the duty cycle of the switching element 442 may be based on the comparison signal generated by the regulator 480.

In some embodiments, the regulator 480 may receive the electrical signal at V_{OUT} and a reference signal at V_{REF}. In these and other embodiments, V_{REF} may be a voltage that V_{OUT} is to be equal or similar to. In some embodiments, V_{REF} may be statically set prior to operation of the system 400 or V_{REF} may be dynamically set during operation of the system 400. In some embodiments, V_{REF} may be independent of the various voltages of the electrical signal within the system 400. Additionally or alternatively, the regulator 480 may receive a third clock signal generated by the third clock generator 490.

In some embodiments, the regulator 480 may compare V_{REF} and V_{OUT} and may generate a comparison signal based on a voltage difference between V_{REF} and V_{OUT} and the third clock signal. In these and other embodiments, a duty cycle of internal components of the regulator 480 may be based on the third clock signal. In some embodiments, the third clock signal may be a pulse width modulated signal, which may provide a digital high voltage or digital low voltage so as to vary an amounts of time the third clock signal is a digital high voltage so as to provide an analog current to the internal components of the regulator 480. In some embodiments, a voltage of the comparison signal may be based on an amount of the voltage difference between V_{REF} and V_{OUT} and the third clock signal. In some embodiments, the regulator 480 may be a buck switching regulator.

In some embodiments, the switching element 442 may adjust V_{INT4} so as to cause V_{OUT} to approach V_{REF} based on the comparison signal. In these and other embodiments, the comparison signal, which may be a variable signal, may control a duty cycle of the switching element 442. For example, the switching element 442 may include a PFET with a gate configured to receive the comparison signal, the comparison signal may drive the gate of the PFET to bias the PFET so as to adjust V_{INT4}.

In some embodiments, if V_{OUT} is the same or similar to V_{REF}, the first clock generator 410, the second clock generator 420, and/or the third clock generator 490 may be configured to stop transmitting the various clock signals which may reduce power consumption by the voltage converter stages 450 and/or the regulator 480. In these and other embodiments, if V_{OUT} is the same or similar to V_{REF}, the regulator 480 may not generate the comparison signal.

Modifications, additions, or omissions may be made to FIG. 4 without departing from the scope of the present disclosure. For example, while illustrated as including three voltage converter stages 450, the system 400 may include any number of voltage converter stages 450, such as two voltage converters stages 450 or five voltage converter stages 450. As another example, while illustrated as including three clock generators 410, 420, and 490, the system 400 may include any number of clock generators 410, 420, and 490, such as one clock generator 410, 420, or 490, two clock generators 410, 420, and/or 490, or seven clock generators 410, 420, and 490. As an additional example, while illustrated as including one regulator 480, the system 400 may include any number of regulators 480, such as two regulators 480 or five regulators 480. For example, while illustrated as including a single switching inductive circuit 440, the system 400 may include any number of switching inductive circuits 440, such as three switching inductive circuits 440 or six switching inductive circuits 440. Likewise, while the switching inductive circuit 440 is illustrated as including a single switching element 442, inductor 444, capacitor 448, and diode 446, the switching inductive circuit 440 may include any number of switching elements 442, inductors 444, capacitors 448, and diodes 446, such as four switching elements 442, inductors 444, capacitors 448, and diodes 446 or two switching elements 442, inductors 444 and five capacitors 448, and diodes 446. Additionally, while illustrated as including six flyback capacitors 460 and 462 and three hold capacitors 470, the system 400 may include any number of flyback capacitors 460 and 462 and/or hold capacitors 470, such as one flyback capacitor 460 or 462 or one hold capacitor 470, three flyback capacitors 460 and 462 and hold capacitors 470, or twelve flyback capacitors 460 and 462 and six hold capacitors 470.

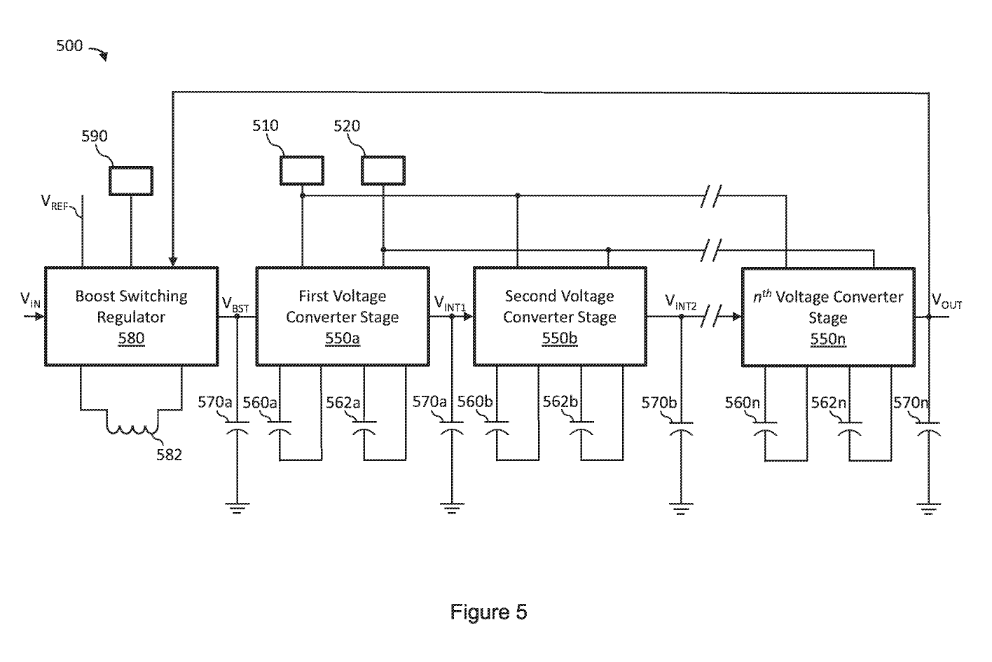

FIG. 5 illustrates another example system of electrical components implementing voltage conversion, in accordance with one or more embodiments of the present disclosure. The system 500 may include a first clock generator 510, a second clock generator 520, a third clock generator 590, a boost switching regulator 580, and multiple voltage converter stages 550 (such as first voltage converter stage 550a, second voltage converter stage 550b, . . . and n^{th} voltage converter stage 550n). The first clock generator 510 and the second clock generator 520 may be similar or comparable to the first clock generator 510 and the second clock generator 520 discussed in conjunction with FIG. 1. The third clock generator 590 may be similar or comparable to the third clock generator 490 discussed in conjunction with FIG. 4. Additionally, the system 500 may include multiple flyback capacitors 560a-n and 562a-n and hold capacitors 570a-n. The flyback capacitors 560a-n and 562a-n and the hold capacitors 570a-n may be similar or comparable to the flyback capacitors 160a-n and 162a-n and the hold capacitors 170a-n discussed in conjunction with FIG. 1.

In some embodiments, the system 500 may implement a voltage conversion circuit configured to receive an electrical signal at voltage V_{IN} and convert and output the electrical signal at voltage V_{OUT}. In these and other embodiments, the system 500 may implement an up converter in which each voltage converter stage 550 and the boost switching regulator 580 may multiply the voltage of the electrical signal, and V_{OUT} may be greater than V_{IN}.

In some embodiments, the voltage converter stages 550 may be electrically coupled in a cascaded configuration similar to the voltage converter stages 150 discussed in conjunction with FIG. 1. In these and other embodiments, the voltage converter stages 550 may be unregulated such that a duty cycle of internal components of the voltage converter stages 550 are based on fixed clock signals. For example, the duty cycle of the internal components of the voltage converter stages 550 may be based on a first clock signal generated by the first clock generator 510 and a second clock signal generated by the second clock generator 520 as discussed above in conjunction with FIG. 1.

In some embodiments, the first voltage converter stage 550a may receive the electrical signal at V_{BST} from the boost switching regulator 580 and may convert the voltage of the electrical signal to V_{INT1} and may output the electrical signal at V_{INT1} based on V_{BST}, the first clock signal, and the second clock signal. Likewise, the second voltage converter stage 550b may receive the electrical signal at V_{INT1} and may convert the voltage of the electrical signal to V_{INT2} and may output the electrical signal at V_{INT2} based on V_{INT1}, the first clock signal, and the second clock signal. In these and other embodiments, the n^{th} voltage converter stage 550n may receive the electrical signal at V_{INT2} and may convert the voltage of the electrical signal to V_{OUT} and may output the electrical signal at V_{OUT} based on V_{INT2}, the first clock signal, and the second clock signal.

In some embodiments, the boost switching regulator 580 may be electrically coupled in series with the first voltage converter stage 550a. In these and other embodiments, the boost switching regulator 580 may receive the electrical signal at V_{IN}, a reference signal at V_{REF}, and the electrical signal at V_{OUT}. Additionally or alternatively, the boost switching regulator 580 may receive a third clock signal generated by the third clock generator 590. In some embodiments, a duty cycle of internal components of the boost switching regulator 580 may be based on the third clock signal. In these and other embodiments, the third clock signal may be a pulse width modulated signal, which may provide a digital high voltage or digital low voltage so as to vary an amounts of time the third clock signal is a digital high voltage so as to provide an analog current to the internal components of the boost switching regulator 580.

In some embodiments, V_{REF} may be a voltage that V_{OUT} is to be equal or similar to. In these and other embodiments, V_{REF} may be statically set prior to operation of the system 500 or V_{REF} may be dynamically set during operation of the system 500. In these and other embodiments, V_{REF} may be independent of the various voltages of the electrical signal within the system 500. In some embodiments, the boost switching regulator 580 may multiply (e.g., boost) the voltage of the electrical signal to V_{BST} based on V_{IN}, V_{OUT}, and the third clock signal. In these and other embodiments, the boost switching regulator 580 and may output the electrical signal at V_{BST}.

In some embodiments, the boost switching regulator 580 may compare V_{REF} and V_{OUT} and may adjust V_{BST} based on a voltage difference between V_{REF} and V_{OUT} and the third clock signal. In these and other embodiments, the boost switching regulator 580 may adjust V_{BST} so as to cause V_{OUT} to approach V_{REF}. In some embodiments, the boost switching regulator 580 may be electrically coupled to an inductor 582. In these and other embodiments, the inductor 582 may be driven by the third clock signal to regulate V_{BST} of the electrical signal. Additionally or alternatively, the inductor 582 may be included within the boost switching regulator 580.

Modifications, additions, or omissions may be made to FIG. 5 without departing from the scope of the present disclosure. For example, while illustrated as including three voltage converter stages 550, the system 500 may include any number of voltage converter stages 550, such as two voltage converters stages 550 or five voltage converter stages 550. As another example, while illustrated as including three clock generators 510, 520, and 590, the system 500 may include any number of clock generators 510, 520, and 590, such as one clock generator 510, 520, or 590, two clock generators 510, 520, and/or 590, or seven clock generators 510, 520, and 590. As an additional example, while illustrated as including one boost switching regulator 580, the system 500 may include any number of boost switching regulator 580, such as three boost switching regulators 580 or nine boost switching regulators 580. Likewise, while illustrated as including a single inductor 582, the system 500 may include any number of inductors 582, such as seven inductors 582 or two inductors 582. Additionally, while illustrated as including six flyback capacitors 560 and 562 and four hold capacitors 570, the system 500 may include any number of flyback capacitors 560 and 562 and/or hold capacitors 570, such as one flyback capacitor 560 or 562 or one hold capacitor 570, three flyback capacitors 560 and 562 and hold capacitors 570, or twelve flyback capacitors 560 and 562 and six hold capacitors 570.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A voltage conversion circuit comprising:
a first stage voltage converter configured to:
receive an input signal at a first voltage level;
receive a first clock signal and a second clock signal; and
generate an intermediate signal at a second voltage level based on the input signal, the first clock signal, and the second clock signal;
a second stage voltage converter electrically coupled in series with the first stage voltage converter and configured to:
receive the intermediate signal;
receive the second clock signal and a combined comparison signal; and
generate an output signal at a third voltage level based on the intermediate signal, the combined comparison signal, and the second clock signal;
a comparison circuit electrically coupled in parallel to the second stage voltage converter and configured to:
receive a reference signal at a fourth voltage level;
receive the output signal and the first clock signal;
compare the reference signal and the output signal; and
generate the combined comparison signal based on the first clock signal and the comparison of the reference signal and the output signal, wherein the second stage voltage converter is configured to adjust the third voltage level of the output signal to approach the fourth voltage level of the reference signal based on the combined comparison signal.

2. The voltage conversion circuit of claim 1, wherein the comparison circuit comprises:
a comparator configured to:
receive the reference signal and the output signal;
compare the reference signal and the output signal; and
generate a comparison signal based on the comparison of the reference signal and the output signal; and
a logic circuit configured to:
receive the first clock signal and the comparison signal; and
generate the combined comparison signal based on the first clock signal and the comparison signal.

3. The voltage conversion circuit of claim 1, wherein the comparison circuit is electrically coupled to the first stage voltage converter, wherein the first stage voltage converter is configured to:
receive the combined comparison signal; and
generate the intermediate signal based on the input signal, the combined comparison signal, and the second clock signal.

4. The voltage conversion circuit of claim 1, wherein the comparison circuit includes a first comparison circuit, the reference signal includes a first reference signal, the combined comparison signal includes a first combined comparison signal, and the first stage voltage converter is configured to receive a second combined comparison signal, the voltage conversion circuit comprising:
a second comparison circuit electrically coupled in parallel to the first stage voltage converter and configured to:
receive a second reference signal at a fifth voltage level;
receive the intermediate signal and the first clock signal;
compare the second reference signal and the intermediate signal; and
generate the second combined comparison signal based on the first clock signal and the comparison of the second reference signal and the intermediate signal, wherein the first stage voltage converter is configured to adjust the second voltage level of the intermediate signal to approach the fifth voltage level of the second reference signal based on the second combined comparison signal.

5. The voltage conversion circuit of claim 1, wherein the comparison circuit is configured to stop generating the combined comparison signal in response to the third voltage level of the output signal being the same or similar to the fourth voltage level of the reference signal.

6. The voltage conversion circuit of claim 1, wherein the second clock signal includes an electrical signal generated by a Dickson charge pump.

7. The voltage conversion circuit of claim 1, wherein the first stage voltage converter comprises a first capacitive element and a second capacitive element.

8. The voltage conversion circuit of claim 7, wherein the voltage conversion circuit comprises a third capacitive element electrically coupled to the first stage voltage converter and the second stage voltage converter and ground.

9. A voltage conversion circuit comprising:
a multiple stage voltage converter configured to:
receive an input signal at a first voltage level;
receive a first clock signal and a second clock signal; and
generate an intermediate signal at a second voltage level based on the input signal, the first clock signal, and the second clock signal;
a switching inductive circuit electrically coupled in series with the multiple stage voltage converter and configured to:
receive the intermediate signal;
receive a comparison signal; and
generate an output signal at a third voltage level based on the intermediate signal and the comparison signal; and
a regulator circuit electrically coupled in parallel to the switching inductive circuit and configured to:
receive the output signal;
receive a reference signal at a fourth voltage level;
receive a third clock signal;
compare the output signal and the reference signal; and
generate the comparison signal based on the third clock signal and the comparison of the output signal and the reference signal, wherein the switching inductive circuit is configured to adjust the third voltage level of the output signal to approach the fourth voltage level of the reference signal based on the comparison signal.

10. The voltage conversion circuit of claim 9, wherein the switching inductive circuit comprises a FET transistor, an inductor, a capacitor, and a diode.

11. The voltage conversion circuit of claim 9, wherein the switching inductive circuit comprises:
a switching element configured to:
receive the intermediate signal and the comparison signal; and
generate an internal signal based on the comparison signal and the intermediate signal; and
an inductive circuit configured to:
receive the internal signal; and
generate the output signal by modifying the internal signal.

12. The voltage conversion circuit of claim 9, wherein the second clock signal includes an electrical signal generated by a Dickson charge pump.

13. The voltage conversion circuit of claim 9, wherein the third clock signal includes a pulse width modulated signal.

14. The voltage conversion circuit of claim 9, wherein the multiple stage voltage converter comprises:
a first stage voltage converter;
a second stage voltage converter electrically coupled in series with the first stage voltage converter;
a first capacitive element electrically coupled in series with the first stage voltage converter;
a second capacitive element electrically coupled to the first stage voltage converter;
a third capacitive element electrically coupled to the second stage voltage converter; and
a fourth capacitive element electrically coupled to the second stage voltage converter.

15. The voltage conversion circuit of claim 14, wherein the voltage conversion circuit comprises a fifth capacitive element electrically coupled to the first stage voltage converter, the second stage voltage converter and ground.

16. A voltage conversion circuit comprising:
a multiple stage voltage converter configured to:
receive a boost signal at a first voltage level;
receive a first clock signal and a second clock signal; and
generate an output signal at a second voltage level based on the boost signal, the first clock signal, and the second clock signal; and
a boost switching regulator electrically coupled in series with the multiple stage voltage converter and configured to:
receive an input signal, a third clock signal, and the output signal;
receive a reference signal at a third voltage level;
compare the reference signal and the output signal; and
generate the boost signal based on the input signal, the third clock signal, and the comparison of the reference signal and the output signal, wherein the boost switching regulator is configured to adjust the first voltage level of the boost signal to cause the second voltage level of the output signal generated by the multiple stage voltage converter to approach the third voltage level of the reference signal.

17. The voltage conversion circuit of claim 16, wherein the second clock signal includes an electrical signal generated by a Dickson charge pump.

18. The voltage conversion circuit of claim 16, wherein the third clock signal includes a pulse width modulated signal.

19. The voltage conversion circuit of claim 16, wherein the boost switching regulator comprises an inductive circuit that is driven by the third clock signal and is configured to regulate the first voltage level of the boost signal.

20. The voltage conversion circuit of claim 16, wherein the multiple stage voltage converter comprises:
a first stage voltage converter;
a second stage voltage converter electrically coupled in series with the first stage voltage converter;
a first capacitive element electrically coupled to the first stage voltage converter;
a second capacitive element electrically coupled to the first stage voltage converter;
a third capacitive element electrically coupled to the second stage voltage converter;
a fourth capacitive element electrically coupled to the second stage voltage converter; and
a fifth capacitive element electrically coupled to the first stage voltage converter, the second stage voltage converter, and ground.
